(19) United States
(12) Patent Application Publication
(10) Pub. No.: US 2024/0060605 A1
(43) Pub. Date: Feb. 22, 2024

(54) METHOD, INTERNET OF THINGS (IOT) SYSTEM, AND STORAGE MEDIUM FOR SMART GAS ABNORMAL DATA ANALYSIS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Yaqiang QUAN, Chengdu (CN)

(73) Assignee: CHENGDU QINCHUAN IOT TECHNOLOGY CO., LTD., Chengdu (CN)

(21) Appl. No.: 18/497,992

(22) Filed: Oct. 30, 2023

(30) Foreign Application Priority Data
Sep. 15, 2023 (CN) 202311192558.X

(51) Int. Cl. F17D 5/00; G16Y 10/35; G16Y 40/20; G16Y 40/50

(52) U.S. Cl. CPC F17D 5/005; G16Y 10/35; G16Y 40/20; G16Y 40/50

(57) ABSTRACT

A method, an Internet of Things (IoT) system, and a storage medium for smart gas abnormal data analysis are provided. The method may include: obtaining a user feature and a pipeline network transportation feature of each of a plurality of gas users; obtaining a first clustering result and a second clustering result by clustering the gas user based on the user feature and the pipeline network transportation feature respectively, the first clustering result and the second clustering result including one or more gas user clusters, respectively; for any one of the gas user clusters: determining, based on device use data and/or gas metering data of the gas user in the gas user cluster, a potential abnormal gas user; determining a target abnormal user based on the first abnormal user and the second abnormal user; and sending an early warning message to the target abnormal user.

### CROSS-REFERENCE TO RELATED APPLICATION

This application claims priority of Chinese Patent Application No. 202311192558.X, filed on Sep. 15, 2023, the contents of each of which are entirely incorporated herein by reference.

### TECHNICAL FIELD

The present disclosure relates to the technical field of gas data processing, and in particular, to a method, an Internet of Things (IoT) system, and a storage medium for smart gas abnormal data analysis.

### BACKGROUND

An extensive use of a gas has brought great convenience to social production and people's lives. But some individual gas users may engage in abnormal behaviors such as stealing or theft of the gas. The phenomenon may not only cause economic losses to a gas company, but may also affect use experience of other gas users and pose a hidden danger to social security.

There is thus a need to provide a method, an Internet of Things (IoT) system, and a storage medium for a smart gas abnormal data analysis for quickly and accurately determining an anomalous user and performing a timely warning.

### SUMMARY

One of the embodiments of the present disclosure provides a method for smart gas abnormal data analysis. The method may be performed by a smart gas device management platform of a smart gas Internet of Things (IoT) system. The method may include: obtaining a user feature and a pipeline network transportation feature of each of a plurality of gas users; obtaining a first clustering result and a second clustering result by clustering the gas user based on the user feature and the pipeline network transportation feature respectively, the first clustering result and the second clustering result including one or more gas user clusters, respectively; for any one of the gas user clusters: determining, based on device use data and/or gas metering data of the gas user in the gas user cluster, a potential abnormal gas user; the device use data includes a gas device and a gas usage of the gas device, and the gas metering data include a cumulative gas usage value of a plurality of moments; and the potential abnormal gas user includes a first abnormal user and a second abnormal user; determining a target abnormal user based on the first abnormal user and the second abnormal user, the first abnormal user being the potential abnormal gas user determined based on the first clustering result, and the second abnormal user being the potential abnormal gas user determined based on the second clustering result; and sending an early warning message to the target abnormal user.

One of the embodiments of the present disclosure provides an IoT system for gas abnormal data analysis. The system may include a smart gas device management platform. The smart gas device management platform may be configured to perform the method for smart gas abnormal data analysis.

One of the embodiments of the present disclosure provides a computer-readable storage medium. The storage medium may store computer instructions, and when the computer reads the computer instructions in the storage medium, the computer may implement the method for smart gas abnormal data analysis.

### BRIEF DESCRIPTION OF THE DRAWINGS

The present disclosure is further illustrated in terms of exemplary embodiments, which will be described in detail with reference to the accompanying drawings. These embodiments are non-limiting exemplary embodiments, in which like reference numerals represent similar structures throughout the several views of the drawings, where:

FIG. 1 is a schematic diagram illustrating an exemplary platform structure of a smart gas Internet of Things (IoT) system for a smart gas abnormal data analysis according to some embodiments of the present disclosure;

FIG. 2 is a flowchart illustrating an exemplary method for a smart gas abnormal data analysis according to some embodiments of the present disclosure;

FIG. 3 is a schematic diagram illustrating an exemplary process for determining a first abnormal user according to some embodiments of the present disclosure;

FIG. 4 is a schematic diagram illustrating an exemplary outlier user distribution according to some embodiments of the present disclosure;

FIG. 5 is a schematic diagram illustrating an exemplary process for determining a second abnormal user according to some embodiments of the present disclosure; and

FIG. 6 is a schematic diagram illustrating an exemplary process for determining a target abnormal user according to some embodiments of the present disclosure.

### DETAILED DESCRIPTION

To provide a clearer understanding of the technical solutions in the embodiments of the present disclosure, the accompanying drawings that are required for describing the embodiments are briefly introduced below. It is evident that the accompanying drawings in the following description are merely examples or embodiments of the present disclosure, and those skilled in the art may apply the present disclosure to other similar scenarios based on these drawings without exercising inventive effort. Unless clearly indicated by the context or otherwise stated, identical reference numerals in the drawings represent the same structure or operation.

It should be understood that the terms “system”, “device”, “unit”, and/or “module” used herein are employed to distinguish different components, elements, parts, sections, or assemblies at different levels. However, these terms may be replaced by other expressions that achieve the same purpose.

As shown in the present disclosure and the claims, unless the context explicitly indicates otherwise, terms such as “a”, “an”, “one”, and/or “the” do not necessarily denote a singular entity, but may include a plural form. In general, the terms “including” and “comprising” indicate the inclusion of specifically determined operations and elements. However, they do not exclude the presence of other steps or elements.

Flowcharts are used in the present disclosure to illustrate operations performed by a system according to embodiments of the present disclosure. It should be understood that the preceding or following operations are not necessarily performed in a precise order. On the contrary, operations may be processed in reverse order or simultaneously. Additionally, other operations may be added to these processes or a step or steps may be removed from these processes.

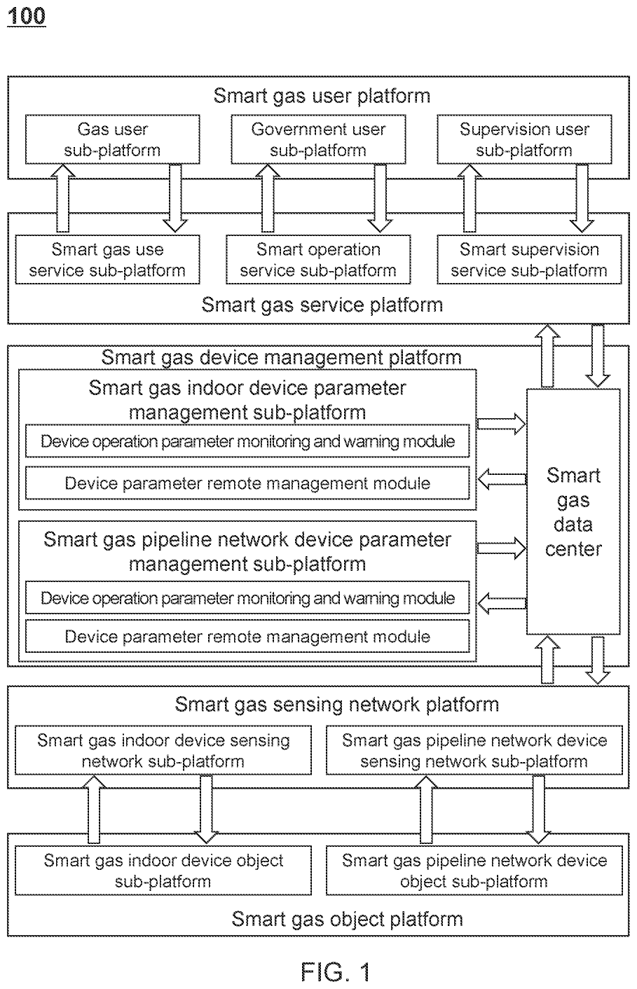

FIG. 1 is a schematic diagram illustrating an exemplary platform structure of a smart gas Internet of Things (IoT) system for a smart gas abnormal data analysis according to some embodiments of the present disclosure. As illustrated in FIG. 1, the IoT system for a smart gas abnormal data analysis may include a smart gas user platform, a smart gas service platform, a smart gas device management platform, a smart gas sensing network platform, and a smart gas object platform.

The smart gas user platform may be a platform for interacting with a user. In some embodiments, the smart gas user platform may be configured as a terminal device.

In some embodiments, the smart gas user platform may include a gas user sub-platform, a government user sub-platform, and a supervision user sub-platform.

The gas user sub-platform may be a platform that provides a gas user with data related to a gas use and solutions to gas problems. The gas user may include an industrial gas user, a commercial gas user, and a general gas user.

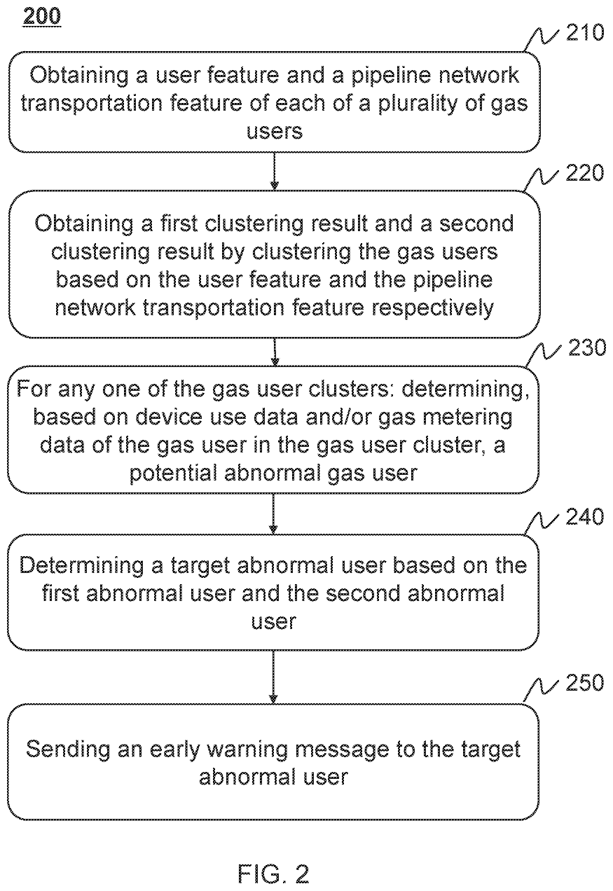

In some embodiments, the smart gas user platform may send an early warning message to the gas user based on the gas user sub-platform. For more information on the early warning message, please refer to FIG. 2 and the related descriptions.

The government user sub-platform may be a platform that provides a government user with data related to a gas operation. The government user may include personnel from government statistics, city operation and management departments, etc.

The supervision user sub-platform may be a platform for a supervision user to supervise the operation of the entire IoT system. The supervision user may be personnel from a safety management department, etc.

The smart gas service platform may be a platform for receiving and transmitting data and/or information.

In some embodiments, the smart gas service platform may include a smart gas use service sub-platform, a smart operation service sub-platform and a smart supervision service sub-platform.

The smart gas use service sub-platform may be a platform that provides the gas user with information related to a gas device.

The smart operation service sub-platform may be a platform that provides the government user with information related to the gas operation.

The smart supervision service sub-platform may be a platform that provides the supervision user with safety supervision-related information.

In some embodiments, various sub-platforms of the smart gas service platform may interact with corresponding sub-platforms of the smart gas user platform.

The smart gas device management platform refers to a platform for overall planning and coordinating connections and cooperation among various functional platforms.

In some embodiments, the smart gas device management platform may include a smart gas indoor device parameter management sub-platform, a smart gas pipeline network device parameter management sub-platform, and a smart gas data center.

The smart gas data center may be configured to store and manage operation information. In some embodiments, the smart gas data center may be configured as a storage device for storing and managing a user feature and a pipeline network transportation feature. For more information on the user feature and the pipeline network transportation feature, please refer to FIG. 2 and the related descriptions.

The smart gas indoor device parameter management sub-platform may be a platform used to process information related to an indoor device.

The smart gas pipeline network device parameter management sub-platform may be a platform used for processing information related to the pipeline network device.

In some embodiments, the smart gas indoor device parameter management sub-platform and the smart gas pipeline network device management sub-platform may include, but not limited to, a device operation parameter monitoring and warning module, and a device parameter remote management module.

The device operation parameter monitoring and warning module may be a module that monitors and warns about operation parameters of the device. In some embodiments, the smart gas indoor device parameter management sub-platform and the smart gas pipeline network device management sub-platform may analyze and process data output from the device operation parameter monitoring and warning module.

The device parameter remote management module may be a module that remotely manages parameters related to the gas device. In some embodiments, the smart gas indoor device parameter management sub-platform and the smart gas pipeline network device management sub-platform may respectively perform a remotely setting, an adjustment, a remotely authorization, etc. on the user feature as well as the pipeline network transportation feature through the device parameter remote management module.

The smart gas sensing network platform may be a functional platform for managing sensing communication. In some embodiments, the smart gas sensing network platform may be configured as a communication network and a gateway.

In some embodiments, the smart gas sensing network platform may include a smart gas indoor device sensing network sub-platform and a smart gas pipeline network device sensing network sub-platform.

The smart gas indoor device sensing network sub-platform may be used to obtain operation information of a gas indoor equipment and may interact with the information of the smart gas indoor device object sub-platform.

The smart gas pipeline network device sensing network sub-platform may be used to obtain the operation information of the gas pipeline network device and interact with the information of the smart gas pipeline network device object sub-platform.

In some embodiments, each sub-platform of the smart gas sensing network platform may perform data interaction with each corresponding sub-platform of the smart gas object platform.

The smart gas object platform may be a functional platform for obtaining information. In some embodiments, the smart gas object platform may be configured as various types of devices, including gas devices and other devices. The gas devices may include indoor devices and pipeline network devices. The other devices may include monitoring devices, etc.

In some embodiments, the smart gas object platform may include, but not limited to, a smart gas indoor device object sub-platform and a smart gas pipeline network device object sub-platform.

In some embodiments, the smart gas indoor device object sub-platform may be configured for various types of indoor gas devices of a gas customer, such as the gas meter of the gas user.

In some embodiments, the gas pipeline network device object sub-platform may be configured for various types of pipeline network devices and monitoring devices. The pipeline network device may include a gas gate station compressor, a gas flow meter, a valve control device, etc. The monitoring device may include a temperature sensor, a pressure sensor, etc.

In some embodiments, the smart gas service platform may interact with the smart gas user platform for information. For example, the smart gas service platform may send an early warning message to the smart gas user platform.

In some embodiments, the smart gas device management platform may interact with the smart gas service platform and the smart gas sensing network platform respectively through the smart gas data center. For example, the smart gas data center may send the early warning message to the smart gas service platform. For another example, the smart gas data center may send an instruction to obtain the user feature as well as the pipeline network transportation feature to the smart gas sensing network platform to obtain the user feature as well as the pipeline network transportation feature.

In some embodiments, the smart gas sensing network platform may perform an information interaction with the smart gas object. For example, the smart gas sensing network platform may send the instruction to the smart gas object platform to obtain the user feature and the pipeline network transportation feature to obtain the user feature and the pipeline network transportation feature, and upload the user feature and the pipeline network transportation feature to the smart gas data center.

For specific descriptions of the foregoing, please refer to the descriptions of FIGS. 2-6 of the present disclosure.

It should be noted that the above description of the system and the components of the system is provided only for descriptive convenience, and does not limit the present disclosure to the scope of the cited embodiments.

FIG. 2 is a flowchart illustrating an exemplary method for a smart gas abnormal data analysis according to some embodiments of the present disclosure. In some embodiments, a process 200 may be performed by a smart gas device management platform. As shown in FIG. 2, the process 200 may include following operations.

In 210, obtaining a user feature and a pipeline network transportation feature of each of a plurality of gas users.

The user feature refers to the feature at a user level. For example, the user feature may include a gas device type, a user type, a monthly usage, etc. In some embodiments, the smart gas device management platform may obtain the user feature through the smart gas user platform.

The pipeline network transportation feature refers to the feature related to a gas transportation in the gas pipeline network. For example, the pipeline network transportation feature may include a complexity degree of the pipeline, and whether the pipeline belongs to the same branch, etc. In some embodiments, the smart gas device management platform may obtain the pipeline network transportation feature through the smart gas object platform.

In 220, obtaining a first clustering result and a second clustering result by clustering the gas users based on the user feature and the pipeline network transportation feature respectively.

In some embodiments, the smart gas device management platform may construct a vector of the gas user based on the user feature; measure the similarity of the user feature using a vector distance, and group them based on the similarity. As a result, the gas users in the same group may have a higher similarity in the user feature, while the gas users in different groups may have a lower similarity in the user feature. Further, the smart gas device management platform may cluster the gas users based on a grouping result to obtain the first clustering result. In some embodiments, the smart gas device management platform may construct the vector of the gas user according to the pipeline network transportation feature and obtain a second clustering result in accordance with a similar mode as described above. The first clustering result as well as the second clustering result each includes one or more gas user clusters.

The gas user cluster refers to a grouping of the gas users. The gas user cluster may include one or more gas users.

The first clustering result refers to one or more gas user clusters obtained by clustering the gas users based on the user feature.

The second clustering result refers to one or more gas user clusters obtained by clustering the gas users based on the pipeline network transportation feature.

In 230, for any one of the gas user clusters: determining, based on device use data and/or gas metering data of the gas user in the gas user cluster, a potential abnormal gas user.

The device use data refers to data related to a gas use situation of a device. For example, the device use data may include a gas device type and a gas usage thereof. In some embodiments, the smart gas device management platform may obtain the device use data through the smart gas object platform.

The gas metering data refers to data related to the gas usage. For example, the gas metering data may include a cumulative gas usage value for a plurality of moments.

The potential abnormal gas user refers to the gas user with a higher probability of experiencing an abnormity. The smart gas device management platform may determine the potential abnormal gas user in various ways. For example, the smart gas device management platform may determine standard device use data and/or standard gas metering data based on historical data. Furthermore, the smart gas device management platform may determine the gas user whose difference between the device use data and/or gas metering data and the standard device use data and/or the standard gas metering data is greater than a data threshold as the potential abnormal gas user.

In some embodiments, the potential abnormal gas user may include a first abnormal user and a second abnormal user.

The first abnormal user refers to the potential abnormal gas user determined based on the first clustering result. The smart gas device management platform may determine the first abnormal user in various ways. For example, the smart gas device management platform may preset a standard user feature corresponding to each of the gas user clusters of the first clustering result. The gas user whose difference between the user feature and the standard user feature is greater than a feature threshold may be determined to be the first abnormal user.

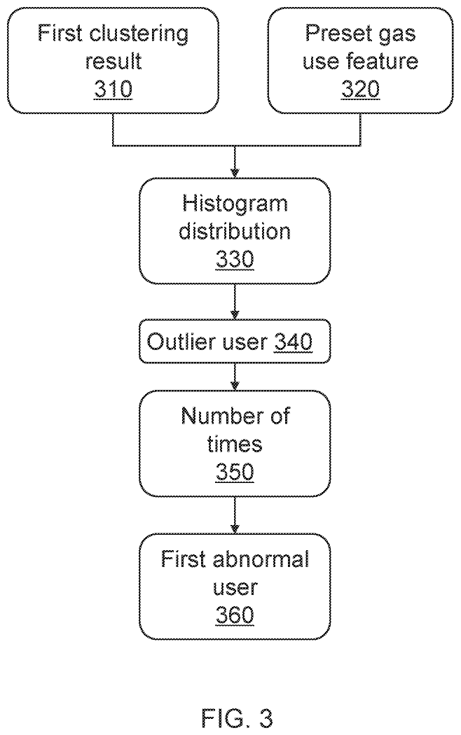

In some embodiments, the smart gas device management platform may determine the first abnormal user based on a histogram distribution. For more detailed descriptions on how the first abnormal user is determined, please refer to FIG. 3 and the related descriptions.

The second abnormal user refers to a potential abnormal gas user determined based on the second clustering result. The smart gas device management platform may determine the second abnormal user in a manner similar to that of determining the first abnormal user.

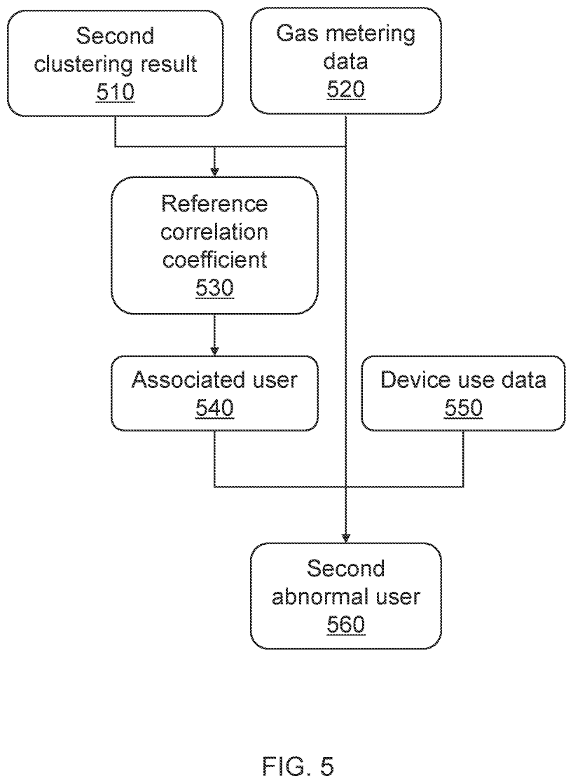

In some embodiments, the smart gas device management platform may further determine the first abnormal user based on a reference correlation coefficient. For more detailed descriptions on how to determine the second abnormal user, please refer to FIG. 5 and the related descriptions.

In 240, determining a target abnormal user based on the first abnormal user and the second abnormal user.

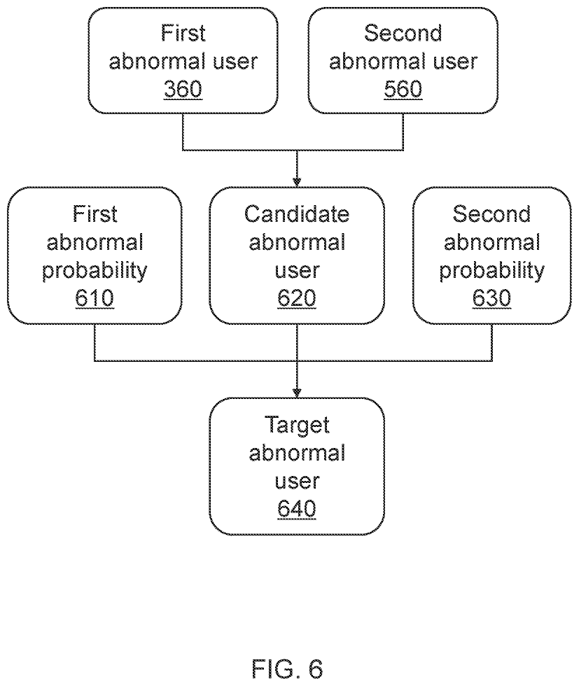

The target abnormal user refers to a user determined as having an abnormity. The smart gas device management platform may determine the target abnormal user in various ways. In some embodiments, the smart gas device management platform may determine the gas user who is both the first abnormal user and the second abnormal user as the target abnormal user. For more detailed descriptions on determining the target abnormal user, please refer to FIG. 6 and the related descriptions.

In 250, sending an early warning message to the target abnormal user.

The early warning message refers to a warning message based on an abnormity. In some embodiments, the early warning message may be determined in advance.

In some embodiments, the smart gas device management platform may send the early warning message to a terminal of the target abnormal user through a text, a voice, etc.

In some embodiments of the present disclosure, by analyzing the device use data and/or the gas metering data of the clustered gas user, the data of a great number of gas users may be collectively screened to determine the potential abnormal gas user and further determine the target abnormal user. In this way, the early warning message can be sent timely to the target abnormal user to avoid potential safety risks and issues such as a gas leakage, thereby improving efficiency and safety of gas management.

It should be noted that the foregoing description of the process is for the purpose of exemplification and illustration only and does not limit the scope of application of the present disclosure. For those skilled in the art, various corrections and changes to the process may be made under the guidance of the present disclosure. However, these corrections and changes remain within the scope of the present disclosure.

FIG. 3 is a schematic diagram illustrating an exemplary process for determining a first abnormal user according to some embodiments of the present disclosure.

In some embodiments, a smart gas device management platform may generate a plurality of histogram distributions 330 based on a plurality of preset gas use features 320 for one or more of gas user clusters in a first clustering result 310; for any one of the histogram distributions 330, the smart gas device management platform may determine one or more outlier users 340 in the histogram distribution 330; the smart gas device management platform may count a number of times 350 that each gas user in the first clustering result 310 is determined to be the outlier user 340 in the plurality of the histogram distributions 330; and, the smart gas device management platform may further determine a first abnormal user 360 in the gas user cluster based on at least the number of times 350.

In some embodiments, the first clustering result 310 may correspond to a clustering parameter including at least one of a gas device type, a user type, and a monthly usage.

The gas device type refers to a type of gas device used by the gas user. In some embodiments, the smart gas device management platform may obtain the gas device type through a smart gas user platform.

The user type refers to a type of a nature of use of the gas user. For example, the user type may include a residential gas user, a commercial gas user, an industrial gas user, etc. In some embodiments, the smart gas device management platform may obtain the user type through the smart gas user platform.

The monthly usage refers to a total amount of gas used by the gas user in a month. In some embodiments, the smart gas device management platform may obtain the monthly usage through a smart gas object platform.

In some embodiments of the present disclosure, the clustering parameter corresponding to the first clustering result may include at least one of the gas device type, the user type, and the monthly usage, which helps to analyze needs and behavioral patterns of the gas users in a more comprehensive manner and makes the first clustering result more accurate and representative.

The preset gas use feature 320 refers to a feature at a gas use level. For example, the preset gas use feature 320 may include an average daily gas usage, an average hourly gas usage, a peak use interval, a gas firing frequency, etc. In some embodiments, the smart gas device management platform may obtain the preset gas use features 320 through the smart gas device management platform.

The histogram distribution 330 refers to a frequency distribution of the preset gas use feature taking different values within a certain range. The frequency distribution may be determined based on historical gas use data of the gas user.

In some embodiments, the smart gas device management platform may generate the histogram distribution 330 based on the preset gas use feature 320 of each gas user in the gas user cluster. For example, the histogram distribution 330 may be generated for one preset gas use feature 320 of a plurality of gas users within one gas user cluster.

The outlier user 340 refers to a user that is significantly different from the other gas users. For example, the smart gas device management platform may determine the gas users whose corresponding data points have abnormal distances from the data points of the other gas users in the histogram distribution as the outlier users 340. For example, the smart gas device management platform may determine an outlier value of each gas user and the other gas users based on the histogram distribution and determine the gas user whose outlier value exceeds a distance threshold as the outlier user 340. In some embodiments, the outlier value may be obtained using the Mahalanobis distance method.

In some embodiments, the smart gas device management platform may count a number of times 350 for each gas user in the first clustering result 310 being determined as the outlier user 340 in the plurality of histogram distributions 330.

In some embodiments, the smart gas device management platform may determine the gas user in each gas user cluster with the highest number of times of being determined as the outlier user 340 as the first abnormal user 360 in the gas user cluster.

In some embodiments, the smart gas device management platform may determine a gas user whose number of times 350 satisfies a preset number of times condition as the first abnormal user 360, and determine a first abnormal probability of the first abnormal user 360.

In some embodiments, the preset number of times condition may include an outlier threshold. For example, the preset number of times condition may be that the number of times 350 that the gas user is determined to be the outlier user 340 exceeds the outlier threshold. In some embodiments, the outlier threshold may be predetermined.

In some embodiments, the outlier threshold may correlate to an outlier degree when the gas user is determined as the outlier user 340. For example, the smaller the outlier degree, the greater the outlier threshold.

The outlier degree may indicate the distance of the outlier user from an interval in the histogram where the distribution is most concentrated. In some embodiments, the outlier degree may be expressed based on the outlier value or may be equivalently replaced, etc.

In some embodiments, the smart gas device management platform may determine a composite outlier degree of the gas user based on the plurality of histogram distributions correspond to the determination of the gas user as the outlier user. The composite outlier degree of the gas user refers to the outlier degree when the gas user is determined as the outlier user. For example, the smart gas device management platform may determine the sum of the corresponding outlier values in the plurality of histogram distributions as the comprehensive outlier degree of the gas user when the gas user is determined as the outlier.

In some embodiments, the smart gas device management platform may weight the outlier degree of the gas user when the gas user is determined as the outlier user 340 for various times in the plurality of the histogram distributions 330; and use the value obtained from the weighting process as the outlier degree of the gas user when the gas user is determined as the outlier user, i.e., the composite outlier degree of the gas user.

In some embodiments, the composite outlier degree of the gas user may also be a weighted sum of the outlier values of the gas user in the plurality of corresponding histogram distributions 330 when the gas user is determined as the outlier user 340.

In some embodiments, the weights during the weighting process may be correlated to the preset gas use feature. For example, the smart gas device management platform may preset weights corresponding to each preset gas use feature; then, based on the histogram distribution corresponding to the preset gas use feature, the weight values corresponding to the outlier values based on the histogram distribution may be determined.

In some embodiments of the present disclosure, by taking the weighted value as the outlier degree when the user is determined as the outlier user, the outlier degree may more accurately reflect the user's behavior.

In some embodiments of the present disclosure, the preset number of times condition may include the outlier threshold, which allows for a comprehensive analysis of the user's gas use behavior and a more accurate determination of the outlier user.

The first abnormal probability for the first abnormal user 360 refers to the probability that the first abnormal user 360 is a target anomalous gas user. In some embodiments, the first abnormal probability may be determined based on the number of times the first abnormal user 360 has been determined as an outlier user and the outlier threshold. For example, the first abnormal probability may be calculated by equation (1):

$$A = \frac{x - {x}_{0}}{{x}_{0}} \times 100 \% \qquad ( 1 )$$

where A denotes the first abnormal probability, x denotes the number of times the user being determined as the outlier user, and x₀ denotes the outlier threshold.

In some embodiments of the present disclosure, the accuracy of determining the first abnormal user may be improved by determining a gas user whose number of times satisfies the preset number of times condition, and a sensitivity of determination may be controlled by adjusting the preset number of times condition.

In some embodiments, the smart gas device management platform may at least determine the first abnormal user 360 based on the number of times 350 using a prediction model.

The prediction model may be a machine learning model. For example, the prediction model may be a deep neural networks (DNN) model, a convolutional neural networks (CNN) model, or a combination thereof.

In some embodiments, an input to the prediction model may include the histogram distribution 330 of each preset gas use feature and an outlier user distribution, and an output may be the first abnormal user 360 and the first abnormal probability.

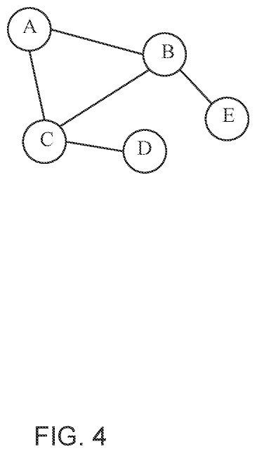

The outlier user distribution refers to the distribution of the number of times where each gas user is determined as the outlier user 340. In some embodiments, the outlier user distribution may be represented using an outlier user distribution map. For more detailed descriptions on the outlier user distribution map, please refer to FIG. 4 and the related contents.

In some embodiments, the prediction model may be trained using a first training sample with a first label. The smart gas device management platform may input a plurality of first training samples with the first labels into an initial prediction model, construct a loss function based on the first labels and an output of the initial prediction model, and iteratively update parameters of the initial prediction model based on the loss function. The model training may be completed when the loss function of the initial prediction model satisfies a preset condition, and the trained prediction model may then be obtained. The preset condition may include a convergence of the loss function and a number of iteration reaches a threshold, etc.

The first training sample may include the histogram distribution of a sample preset gas use feature and a sample outlier user distribution. The first label may be obtained by labeling the sample user actually determined as abnormal in the history among the sample users corresponding to the sample outlier user distribution as 1, and labeling the sample user actually determined as non-abnormal in the history among the sample users corresponding to the sample outlier user distribution as 0. The first training sample and the first label may be obtained based on historical data.

In some embodiments of the present disclosure, the histogram distribution of the preset gas use feature and the outlier user distribution may be processed through the prediction model. A self-learning capability of the machine learning model may be utilized to discover patterns from a great number of the preset gas use features and obtain the correlation between the first abnormal user and the preset gas use features, thereby improving the accuracy and efficiency of determining the first abnormal user.

In some embodiments of the present disclosure, by generating the plurality of histogram distributions for each gas user cluster based on the plurality of preset gas use features and determining the outlier users among them, and determining the first abnormal user based on the number of times, a possible first abnormal user may be discovered more comprehensively, thereby improving a coverage and reliability of the abnormity detection.

FIG. 4 is a schematic diagram illustrating an exemplary outlier user distribution according to some embodiments of the present disclosure.

In some embodiments, an input of the prediction model may include an outlier user distribution map.

The outlier user distribution map refers to a map reflecting an outlier user distribution. In some embodiments, the outlier user distribution map may include a node, a node feature, an edge, an edge feature, etc.

The node may represent a gas user determined as the outlier user. For example, a circles in FIG. 4 may represent the node in the outlier user distribution map.

In some embodiments, the node feature may include a number of times the gas user is determined as the outlier user, an environment where the gas user is located, and historical maintenance data of a gas metering device of the gas user, etc. For more detailed contents on the number of times a gas user is determined as the outlier user, please refer to FIG. 3 and the related descriptions.

The environment where the gas user is located refers to specific environmental condition and situation surrounding the gas user. For example, the environment where the gas user is located may include a geographical environment and a social environment. The geographical environment may include factors such as a location, a weather, a climate, while the social environment may include factors such as a population density, a residents' lifestyles, etc.

The historical maintenance data of the gas metering device refers to maintenance-related data generated when the gas metering device is maintained in the past. For example, the historical maintenance data of the gas metering device may include a maintenance record, a maintenance time, a maintenance location, a maintenance duration, etc.

The edge may correspond to a gas line between the gas users. For example, the lines between the nodes in FIG. 4 may represent the edges of the outlier user distribution map.

In some embodiments, the edge feature may include a distance between the gas users. For example, the edge feature of the edge between node A and node B may include a length of the pipeline corresponding to the edge between the node A and the node B.

In some embodiments, by inputting the outlier user distribution map into the prediction model, an intrinsic correlation between the number of times each user is determined to be the outlier user and the probability of the abnormity may be analyzed, thereby improving the accuracy of determining a potential abnormal gas user.

FIG. 5 is a schematic diagram illustrating an exemplary process for determining a second abnormal user according to some embodiments of the present disclosure.

In some embodiments, a smart gas device management platform may, for one of gas user clusters in a second clustering result 510: for any two gas users in the gas user cluster, calculate, based on the gas metering data 520 of a historical gas user, a reference correlation coefficient 530; determine, based on the reference correlation coefficient 530, at least one associated user 540 of each gas user in the gas user cluster; and determine, based on device use data 550 and the gas metering data 520 of the gas user and the associated user 540 of the gas user, whether the gas user is the second abnormal user 560.

In some embodiments, a clustering parameter corresponding to the second clustering result 510 may include a complexity degree of a pipeline that the gas user is located and whether the pipeline that the gas user is located belongs to the same branch. For further contents of the clustering parameter, please refer to the descriptions of the clustering parameter in a first clustering result.

The complexity degree of the pipeline refers to the complexity of composition of the pipeline. For example, the complexity degree of the pipeline may be related to a type and number of pipeline components, as well as a shape of the pipeline, etc. In some embodiments, the smart gas device management platform may obtain the complexity degree of the pipeline through a smart gas object platform.

The whether the pipeline belongs to the same branch refers to whether the pipeline that the gas user is located belongs to or is located in the same pipeline branch. In some embodiments, the smart gas device management platform may obtain the whether the pipeline belongs to the same branch through the smart gas object platform.

In some embodiments of the present disclosure, the clustering parameter corresponding to the second clustering result may include at least one of the complexity degree of the pipeline and whether the pipeline belongs to the same branch, enabling a more comprehensive analysis of the transportation of the gas pipeline and resulting in a more accurate and representative second clustering result.

For more detailed contents on the gas metering data 520, please refer to FIG. 2 and the related descriptions.

The reference correlation coefficient 530 refers to a parameter determined based on historical gas data of the gas user, which indicates a degree of correlation between two gas users. In some embodiments, the smart gas device management platform may calculate the reference correlation coefficient 530 of the two gas users based on historical gas metering data of any two gas users. For example, the reference correlation coefficients 530 for gas user A and Gas User B may be derived based on equation (2):

$$R = \frac{cov}{{y}_{s t d} \times {z}_{s t d}} \qquad ( 2 )$$

where R denotes the reference correlation coefficient of gas user A and gas user B, cov denotes a covariance of the historical gas metering data of gas user A and gas user B, y_{std} denotes a standard deviation of the historical gas metering data of gas user A, and z_{std} denotes the standard deviation of the historical gas metering data of gas user B.

The associated user 540 refers to other gas users with a relatively high correlation with the gas metering data of the gas user. In some embodiments, the smart gas device management platform may determine the gas user in the gas user cluster whose reference correlation coefficient with a particular gas user is greater than a coefficient threshold as the associated user in the gas user cluster, which in turn determine all the associated users of that gas user.

In some embodiments, the smart gas device management platform may determine the second abnormal user 560 in various ways. For example, the smart gas device management platform may predict future device use data and the gas metering data through a time series analysis based on historical device use data and the gas metering data of the gas users and their associated users 540, and the smart gas device management platform may further determine the gas user whose difference between the device use data 550 and gas metering data 520 and a predicted value exceeds a threshold as the second abnormal user.

In some embodiments, for one gas user, the smart gas device management platform may obtain an actual correlation coefficient between the gas user and the associated user 540, determine a sub-difference between the actual correlation coefficient and the corresponding reference correlation coefficient 530; weight a plurality of sub-differences of the gas user to obtain a composite difference; and in response to the composite difference satisfying a preset difference condition, determine that the gas user is the second abnormal user 560, and calculate a second abnormal probability of the second abnormal user 560.

The actual correlation coefficient refers to a parameter determined based on the current gas data of a gas user that indicates the degree of correlation between the gas user and its associated user 540. In some embodiments, the smart gas device management platform may calculate the actual correlation coefficient based on current gas metering data of the gas user and the associated user 540 thereof. For the specific calculation mode, please refer to the aforementioned calculation of the reference correlation coefficient.

The sub-difference refers to the difference between the actual correlation coefficient and the reference correlation coefficient of the gas user and the associated user 540. In some embodiments, the smart gas device management platform may determine the difference between the actual correlation coefficient and the corresponding reference correlation coefficient 530 as the sub-difference.

The composite difference may indicate the degree of difference between the gas user and all the associated users 540. In some embodiments, the smart gas device management platform may determine the composite difference by weighting the plurality of sub-differences between the gas user and a plurality of the associated users 540.

In some embodiments, the weight of the sub-difference in the weighting process may be positively correlated to the value of the reference correlation coefficient 530. For example, the greater the value of the reference correlation coefficient 530, the greater the weight of the sub-difference determined based on the reference correlation coefficient 530.

In some embodiments of the present disclosure, the weight of the sub-difference may be positively correlated to the value of the reference correlation coefficient, and the difference between gas users with greater reference correlation coefficients may receive higher emphasis, and the composite difference may be assessed more accurately.

In some embodiments, the weights of the sub-differences in the weighting process may correlate to the first clustering result of the gas user and the associated user 540.

For example, if gas user A belongs to the same gas user cluster as the associated user B in the first clustering result, the associated user B may correspond to a greater sub-difference weight.

In some embodiments of the present disclosure, the weight of the sub-difference may be correlated to the first clustering result of the gas user and the associated user, and the difference between the gas users belonging to the same gas user cluster may receive higher emphasis, allowing for a more accurate assessment on the composite difference.

The preset difference condition refers to the condition needs to be satisfied to be determined as gas user composite difference of the second abnormal user 560. In some embodiments, the preset difference condition may include a relationship between the composite difference and the difference threshold. For example, the preset difference condition may be that the composite difference is greater than the difference threshold. The difference threshold may be determined by manual setting.

The second abnormal probability of the second abnormal user 560 refers to the probability that the second abnormal user is a target abnormal gas user. In some embodiments, the second abnormal probability may be determined based on the composite difference and the difference threshold. For example, the second abnormal probability may be calculated using equation (3):

$$B = \frac{t - {t}_{0}}{{t}_{0}} \times 100 \% \qquad ( 3 )$$

where B denotes the second abnormal probability, t denotes the composite difference, and t₀ denotes the difference threshold.

In some embodiments of the present disclosure, the composite difference may be calculated based on the actual correlation coefficient and the corresponding reference correlation coefficient. In this way, a current use situation of the associated user may be considered to improve the accuracy of determining the second abnormal user.

In some embodiments of the present disclosure, at least one associated user may be determined based on the reference correlation coefficient. By analyzing the device use data and the gas metering data of the gas user and the associated user of the gas user, it may be possible to determine whether the gas user is the second abnormal user. In this way, the potential second abnormal user may be effectively determined by considering the correlation between the users, thereby improving a coverage and reliability of abnormal detection.

FIG. 6 is a schematic diagram illustrating an exemplary process for determining a target abnormal user according to some embodiments of the present disclosure.

In some embodiments, the smart gas device management platform may determine a user belonging to both the first abnormal user 360 and the second abnormal user 560 as a candidate abnormal user 620; and determine a target abnormal user 640 based on the candidate abnormal user 620. The first abnormal probability 610 and the second abnormal probability 630 of the target abnormal user 640 may satisfy a preset probability condition.

The candidate abnormal user 620 refers to a gas user determined as the target abnormal user 640.

The preset probability condition refers to the condition needs to be satisfied for the gas user to be determined as the target abnormal user.

In some embodiments, the preset probability condition may be correlated with a first preset probability. For example, the preset probability condition may include at least one of the first abnormal probability 610 and the second abnormal probability 630 being greater than the first preset probability. The first preset probability may be preset in the system.

In some embodiments, the first preset probability may be correlated with at least one of an outlier threshold and a difference threshold. For example, the first preset probability may be negatively correlated with both the outlier threshold and the difference threshold. For more detailed contents on the outlier threshold, please refer to FIG. 3 and the related descriptions. For more detailed contents of the difference threshold, please refer to FIG. 5 and the related descriptions.

In some embodiments of the present disclosure, the greater the outlier threshold and the difference threshold, the looser the monitoring of abnormities. At this time, the first preset probability may be appropriately reduced to increase an intensity of abnormity monitoring, making a selection of target abnormal gas user more reasonable.

In some embodiments, the preset probability condition may include a probability summation value being greater than the first preset probability.

The probability summation value refers to a weighted summation value of the first abnormal probability 610 and the second abnormal probability 620. In some embodiments, the weights of the weighted summation may be preset.

In some embodiments of the present disclosure, the preset probability condition may include the probability summation value being greater than the first preset probability. In this way, situations where both the first abnormal user and the second abnormal user simultaneously appear may be fully considered, thereby more accurately determine the target abnormal user.

In some embodiments, the smart gas device management platform may determine the candidate abnormal user whose first abnormal probability and second abnormal probability satisfy the preset probability condition among the candidate abnormal users as the target abnormal user.

Some embodiments of the present disclosure provide a non-transitory computer-readable storage medium storing computer instructions. When reading the computer instructions in the storage medium, a computer implements the method for smart gas abnormal data analysis.

The basic concepts have been described above. It is apparent to those skilled in the art that the detailed disclosure above is merely provided as an example and does not limit the present disclosure. Although not explicitly stated here, various modifications, improvements, and amendments may be made to the present disclosure by those skilled in the art. Such modifications, improvements, and amendments are suggested in the present disclosure. Therefore, they fall within the spirit and scope of the exemplary embodiments of the present disclosure.

In addition, specific terms are used in the present disclosure to describe embodiments of the present disclosure. For example, “an embodiment”, “one embodiment”, and/or “some embodiments” refer to a feature, a structure, or a characteristic associated with at least one embodiment of the present disclosure. Accordingly, it should be emphasized and noted that the mentions of “an embodiment” or “a number of embodiments” in different locations in the present disclosure are not intended to refer to the same embodiment. Similarly, the mention of “an embodiment” or “an alternative embodiment” in different locations in the present disclosure does not necessarily refer to the same embodiment. Furthermore, certain features, structures, or characteristics in one or more embodiments of the present disclosure may be suitably combined.

Additionally, unless expressly stated in the claims, the order of the processing elements and sequences, the use of numerical letters, or the use of other names as described in the present disclosure are not intended to limit the order of the processes and methods of the present disclosure. While some embodiments of the invention that are currently considered useful are discussed in the foregoing disclosure by way of various examples, it should be appreciated that such details serve only illustrative purposes, and that the additional claims are not limited to the disclosed embodiments. Rather, the claims are intended to cover all amendments and equivalent combinations that are consistent with the substance and scope of the embodiments of the present disclosure. For example, although the various components described above may be implemented as hardware devices, they may also be implemented in software-only solutions, such as an installation on an existing server or mobile device.

Similarly, it should be noted that in order to simplify the presentation of the present disclosure, and help the understanding of one or more embodiments of the invention, the foregoing descriptions sometimes group a plurality of features together in a single embodiment, accompanying drawings, or a description thereof. However, this method of disclosure does not imply that the objects of the present disclosure require more features than those mentioned in the claims. Rather, the claimed subject matter may lie in less than all the features of a single disclosed embodiment.

Numbers describing the quantity of components, attributes, and properties are used in some embodiments, and it should be understood that such numbers used in the description of embodiments are modified in some examples by the modifiers “about”, “approximately”, or “substantially”. “About,” “approximately,” or “generally” is used in some examples. Unless otherwise noted, the terms “about,” “approximate,” or “approximately” indicate that a ±20% variation in the stated number is allowed. Correspondingly, in some embodiments, the numerical parameters used in the present disclosure and the claims are approximate values, which may change depending on the desired characteristics of the individual embodiment. In some embodiments, the numerical parameters should consider the specified number of significant digits and use a general method of significant digit retention. While the numerical ranges and parameters used in some embodiments of the present disclosure to determine the breadth of their scopes are approximations, in specific embodiments, such values are set as precisely as possible within a feasible range.

For each patent, patent application, patent application disclosure, and other materials cited in the present disclosure, such as articles, books, specification sheets, publications, documents, etc., the entire contents of which are hereby incorporated by reference into the present disclosure. Except for application history documents that are inconsistent with or create a conflict with the contents of the present disclosure, and except for documents that limit the broadest scope of the claims of the present disclosure (currently or hereafter appended to the present disclosure). It should be noted that to the extent that the descriptions, definitions, and/or use of terms in the materials appended to the present disclosure are inconsistent with or in conflict with the content set forth in the present disclosure, the descriptions, definitions, and/or use of terms in the present disclosure shall prevail.

Finally, it should be understood that the embodiments described in the present disclosure are only used to illustrate the principles of the embodiments of the present disclosure. Other variations may also fall within the scope of the present disclosure. As such, alternative configurations of embodiments of the present disclosure may be viewed as consistent with the teachings of the present disclosure as an example, not as a limitation. Correspondingly, the embodiments of the present disclosure are not limited to the embodiments expressively presented and described herein.

What is claimed is:

1. A method for smart gas abnormal data analysis performed by a smart gas device management platform of a smart gas Internet of Things (IoT) system, comprising:
obtaining a user feature and a pipeline network transportation feature of each of a plurality of gas users;
obtaining a first clustering result and a second clustering result by clustering the gas user based on the user feature and the pipeline network transportation feature respectively, the first clustering result and the second clustering result including one or more gas user clusters, respectively;
for any one of the gas user clusters:
determining, based on device use data and/or gas metering data of the gas user in the gas user cluster, a potential abnormal gas user; wherein the device use data includes a gas device and a gas usage of the gas device, and the gas metering data include a cumulative gas usage value of a plurality of moments; and the potential abnormal gas user includes a first abnormal user and a second abnormal user;
determining a target abnormal user based on the first abnormal user and the second abnormal user, the first abnormal user being the potential abnormal gas user determined based on the first clustering result, and the second abnormal user being the potential abnormal gas user determined based on the second clustering result; and
sending an early warning message to the target abnormal user.

2. The method of claim 1, wherein the determining, based on device use data and/or gas metering data of the gas user in the gas user cluster, a potential abnormal gas user comprises:
for one or more of the gas user clusters in the first clustering result, generating, based on a plurality of preset gas use features, a plurality of histogram distributions respectively;
for any one of the histogram distributions, determining one or more outlier users in the histogram distribution;
counting a number of times for each gas user in the first clustering result being determined as the outlier user in the plurality of histogram distributions; and
determining, at least based on the number of times, the first abnormal user in the gas user cluster.

3. The method of claim 2, wherein a clustering parameter corresponding to the first clustering result includes at least one of a gas device type, a user type, and a monthly usage.

4. The method of claim 2, wherein the determining, at least based on the number of times, the first abnormal user in the gas user cluster comprises:
determining the gas user whose number of times satisfies a preset number of times condition as the first abnormal user, and determining a first abnormal probability of the first abnormal user.

5. The method of claim 4, wherein the preset number of times condition includes an outlier threshold, the outlier threshold being related to an outlier degree of the gas user when the gas user is determined as the outlier user; the outlier degree being determined based on the histogram distribution.

6. The method of claim 5, wherein a determination of the outlier degree of the gas user when the gas user is determined as the outlier user comprises: weighting the outlier degrees when the gas user is determined as the outlier user for more than one time, determining a weighted value as the outlier degree when the gas user is determined as the outlier user, the weighting being related to the preset gas use feature.

7. The method of claim 2, wherein the determining, at least based on the number of times, the first abnormal user in the gas user cluster comprises:
determining, at least based on the number of times, the first abnormal user through a prediction model, the prediction model being a machine learning model.

8. The method of claim 7, wherein an input of the prediction model includes an outlier user distribution map;
a node of the outlier user distribution map corresponds to the gas user determined as the outlier user, and a node feature of the node includes the number of times the gas user being determined as the outlier user, an environment where the gas user is located, and historical maintenance data of a gas metering device of the gas user; and
an edge of the outlier user distribution map corresponds to a gas pipeline between the gas users, the edge feature of the edge includes a distance between the gas users.

9. The method of claim 1, wherein the determining, based on device use data and/or gas metering data of the gas user in the gas user cluster, a potential abnormal gas user comprises:
for one of the gas user clusters in the second clustering result,
for any two of the gas users in the gas user cluster, calculating, based on the gas metering data of a historical gas user, a reference correlation coefficient;
determining, based on the reference correlation coefficient, at least one associated user of each gas user in the gas user cluster; and
determining, based on the device use data and the gas metering data of the gas user and the associated user of the gas user, whether the gas user is the second abnormal user.

10. The method of claim 9, wherein a clustering parameter corresponding to the second clustering result includes at least one of a complexity degree of a pipeline, and whether the pipeline belongs to a same branch.

11. The method of claim 9, wherein the determining, based on the device use data and the gas metering data of the gas user and the associated user of the gas user, whether the gas user is the second abnormal user comprises:
for one of the gas users,
obtaining an actual correlation coefficient between the gas user and the associated user;
determining a sub-difference between the actual correlation coefficient and a corresponding reference correlation coefficient;
obtaining a composite difference by weighting a plurality of sub-differences of the gas user; and
in response to the composite difference satisfying a preset difference condition, determining that the gas user is the second abnormal user, and calculating a second abnormal probability of the second abnormal user.

12. The method of claim 11, wherein in a weighting process, a weight of the sub-difference is positively correlated to the reference correlation coefficient.

13. The method of claim 11, wherein in a weighting process, a weight of the sub-difference is correlated to the first clustering result of the gas user and the associated user.

14. The method of claim 1, wherein the determining a target abnormal user based on the first abnormal user and the second abnormal user comprises:
determining a user belonging to both the first abnormal user and the second abnormal user as a candidate abnormal user; and
determining, based on the candidate abnormal user, the target abnormal user, the first abnormal probability and the second abnormal probability of the target abnormal user satisfying a preset probability condition.

15. The method of claim 14, wherein the preset probability condition includes a first preset probability, the first preset probability being related to at least one of the outlier threshold and a difference threshold.

16. The method of claim 15, wherein the preset probability condition includes a probability summation value being greater than the first preset probability, the probability summation value being a weighted summation value of the first abnormal probability and the second abnormal probability.

17. A smart gas Internet of Things (IoT) system for gas abnormal data analysis, comprising a smart gas device management platform, wherein the smart gas device management platform is configured to:
obtain a user feature and a pipeline network transportation feature of each of a plurality of gas users;
obtain a first clustering result and a second clustering result by clustering the gas user based on the user feature and the pipeline network transportation feature respectively, the first clustering result and the second clustering result including one or more gas user clusters, respectively;
for one gas user cluster,
determine based on device use data and/or gas metering data of the gas user in the gas user cluster, a potential abnormal gas user; wherein the device use data includes a gas device and a gas usage of the gas device, and the gas metering data include a cumulative gas usage values of a plurality of moments; and the potential abnormal gas user includes a first abnormal user and a second abnormal user;
determine a target abnormal user based on the first abnormal user and the second abnormal user, the first abnormal user being the potential abnormal gas user determined based on the first clustering result, and the second abnormal user being the potential abnormal gas user determined based on the second clustering result; and
send a early early warning message to the target abnormal user.

18. The smart gas IoT system of claim 17, further comprising a smart gas user platform, a smart gas service platform, a smart gas sensing network platform, and a smart gas object platform that interact in sequence;
the smart gas service platform is configured to send the early early warning message to the smart gas user platform;
the smart gas object platform is configured to obtain a gas user feature, a gas pipeline network transportation feature, the device use data and the gas metering data, and transmit the gas user feature, the gas pipeline network transportation feature, the device use data and the gas metering data to the smart gas device management platform via the smart gas sensing network platform; wherein
the smart gas user platform includes a gas user sub-platform, a government user sub-platform, and a supervision user sub-platform;
the smart gas service platform includes a smart gas use service sub-platform, a smart operation service sub-platform, and a smart supervision service sub-platform;
the smart gas device management platform includes a smart gas indoor device parameter management sub-platform, a smart gas pipeline network device parameter management sub-platform, and a smart gas data center, wherein the smart gas indoor device parameter management sub-platform includes a device operation parameter monitoring and warning module and a device parameter remote management module, and the smart gas pipeline network device parameter management sub-platform includes a device operation parameter monitoring and warning module and a device parameter remote management module;
the smart gas sensing network platform includes a smart gas indoor device sensing network sub-platform and a smart gas pipeline network device sensing network sub-platform; and
the smart gas object platform includes a smart gas indoor device object sub-platform and a smart gas pipeline network device object sub-platform.

19. A non-transitory computer-readable storage medium storing computer instructions, wherein when reading the computer instructions in the storage medium, a computer implements the method for smart gas abnormal data analysis of claim 1.
